(19) United States
(12) Patent Application Publication
(10) Pub. No.: US 2015/0076747 A1
(43) Pub. Date: Mar. 19, 2015

(54) System and method for transforming plastic parisons with recovery of blowing air

(71) Applicant: Krones AG, Neutraubling (DE)

(72) Inventors: Frank Winzinger, Regensburg (DE); Eduard Handschuh, Donaustauf (DE); Katharina Seidenberg, Karlsruhe (DE)

(21) Appl. No.: 14/474,272

(22) Filed: Sep. 1, 2014

(30) Foreign Application Priority Data
Sep. 13, 2013 (DE) 10 2013 110 132.1

(51) Int. Cl. B29C 49/62; B29C 49/46

(52) U.S. Cl. CPC B29C 49/62; B29C 49/46; B29C 2049/4697; B29K 2105/258
USPC 264/526; 425/88

(57) ABSTRACT

A system (1) for transforming plastic parisons (10) into plastic containers (10a) with a clean room (20), with at least one blow station (8) comprising a blow mold for shaping the plastic parisons (10) by means of at least one process pressure (p1, p2, pi) and with a venting device (3) for venting the process pressure, or a process pressure reduced to recovery pressure (R), into the atmosphere (U), in which the venting device (3) comprises at least one gas pressure changing device (4). According to the invention the gas pressure changing device (4) can adjust and maintain a pressure difference between the clean room (2) and the venting device (3).

### BACKGROUND

The present invention relates to a system and a method for transforming plastic parisons into plastic containers with a clean room, with at least one blow station comprising a blow mold for shaping the plastic parisons by means of at least one process pressure and with a venting device for venting the process pressure, or a process pressure reduced to recovery pressure, into the atmosphere, in which the venting device comprises at least one gas pressure changing device.

Generic systems and methods for transforming plastic parisons into plastic containers in which the treatment of the plastic containers takes place under sterile conditions in a clean room are well known from the prior art.

For example, international patent application WO 2010/020529 A2 describes a system for transforming plastic plastic parisons into plastic containers which has a transport device comprising a plurality of blow stations and a clean room. By means of the clean room aseptic conditions can be permanently ensured during the production of the plastic containers and also during the filling thereof with beverages. In order to be able to reduce the sterilisation efforts in this respect, the region of the transport device on the transforming system where the blow stations are disposed, is disposed within the clean room, and at least one further region of the transport device is disposed outside the clean room. In this way in particular the size of the clean room can be reduced, so that the regions to be sterilised on the transforming system can be kept particularly small.

The U.S. Pat. No. 7,320,586 B2 discloses a system for blow molding preforms in particular into bottles with the aid of a process pressure, wherein the process pressure can be at least partially recovered as a recovery pressure after the transforming of the container in a pressure vessel provided for this purpose, before a correspondingly reduced residual pressure is vented into the open environment. In this case the recovery pressure is understood in particular to be the pressure level which prevails in the bottle after the compressed air recycling and in particular before the start of the venting.

Furthermore it is also known for example from DE 10 2011 10 259 or DE 10 2004 044 260 that for transforming plastic parisons into plastic containers different blowing pressures can be used and exhaust gases of the respective higher pressure can be supplied, after use thereof for expanding a plastic parison, as working gas to the volume of the lower blow pressure. The sterility of the gas is maintained if it has been sterilised beforehand.

However, the problem arises that a proportion of the exhaust gas can only be supplied as working gas to the volume at the lower blowing pressure until the gas pressure of the exhaust gas is just above the lower blowing pressure. DE 10 2004 044 260 also mentions the recovery into a gas volume of which the pressure is below the lower blowing pressure, but then the same problem also arises, since this volume at further reduced pressure often does not satisfy the sterility requirements. Even if this gas volume is supposed to be sterile, exhaust gases from the transformation process which are below this further reduced pressure are discharged into the environment. In this case there is a danger of contamination of the exhaust gas conduits, so that in subsequent transformation processes with this system contaminants can go back into the region provided as sterile. In particular, frequent valve actuations and the turbulent flows inside the conduits (together with substantial pressure differences) resulting therefrom, promote contamination through the exhaust gas conduits and into the sterile region.

WO 2012/153 268 therefore proposes a special arrangement of different exhaust gas conduits and corresponding control of valves by means of which the flow of contaminants back into the sterile region of a system for transforming containers is to be avoided. To this end it is provided that so long as the pressure in the transformed container is above a predetermined pressure the exhaust gas is discharged into a non-sterile region. When the internal pressure in the container then falls below a threshold value and thus also the pressure difference and the flow rate decrease, valves in the exhaust gas conduits are switched so that the remaining exhaust gas is discharged into a sterile region.

However, this procedure for preventing contaminations of the sterile region by the exhaust gas conduits has considerable disadvantages, since on the one hand at least two exhaust gas conduits must be present, of which one must be kept sterile. Moreover a plurality of valves and at least one control device for controlling the valves as a function of the internal pressure in the transformed container are necessary. The necessary multiple movement of the valves with every blowing process and also the resulting flow changes and turbulence in the gas conduits cause noise, which according to current requirements in relation to noise control for the operating staff should be avoided as much as possible.

Furthermore according to WO 2012/153 268 the proportion of unused exhaust gas is discharged into the unsterile region which has a high gas pressure and thus could be used for further processes to save on resources. Only the proportion of the exhaust gas which has a low gas pressure, and therefore no longer exits into the environment with a flow rate which effectively prevents contaminants from being transported back, is returned into the sterile region.

The object of the present invention therefore is to provide a simple and compact possibility for discharging exhaust gases from a process for transforming plastic parisons into plastic containers so that a contamination of the sterile region is prevented.

### SUMMARY OF THE INVENTION

This object is achieved by a system for transforming plastic parisons into plastic containers with a clean room, wherein the system has at least one blow station comprising a blow mold for shaping the plastic parisons by means of at least one process pressure and a venting device for venting the process pressure, or a process pressure reduced to recovery pressure, into the atmosphere, in which the venting device comprises at least one gas pressure changing device, wherein the gas pressure changing device can produce, maintain and in particular adjust a pressure difference between the clean room and/or a drain conduit connected to the clean room and the venting device.

In this case, preferably a higher pressure prevails in the clean room than in the venting device. Preferably, therefore, a gas or air pressure of the venting device or in the venting device is lowered or here a negative pressure and/or a flow in the direction of an outlet is generated or maintained.

The system preferably has a transport device by means of which the plastic parisons are transported along a predefined transport path. In particular the plastic parisons are transported during their expansion or transformation. This transport device preferably has a movable and in particular rotatable carrier on which a plurality of transforming stations or blow stations are disposed for transforming the plastic parisons into the plastic containers.

The individual transforming stations or blow stations preferably each have application devices in order to apply a gaseous medium and in particular blowing air to the plastic parisons for expansion of the latter. In this case a plurality of valve devices can be provided which enable the application to the plastic parisons of different pressure levels, such as for instance a valve for providing a preliminary blow molding pressure, a valve for providing an intermediate blow molding pressure and/or a valve for providing a final blow molding pressure. These respective valve devices may be in flow connection with reservoirs or distributors which store the gaseous medium or distribute it to the individual blow stations. These reservoirs may preferably be designed as annular channels which particularly preferably supply a plurality of transforming stations with the gaseous medium.

In a further preferred embodiment the transforming stations or blow stations each have rod-like members or stretching rods which can be introduced into the plastic parisons during the expansion process in order to expand them in the longitudinal direction.

The clean room is advantageously delimited by means of at least one wall relative to the surroundings. The clean room is particularly preferably delimited by means of at least two walls relative to the surroundings, wherein one wall is movable relative to the other wall. A sealing means which seals a region between the walls which are movable with respect to one another is advantageously provided between these walls. This sealing means may for example be a so-called water lock which has a circumferential channel which can be filled with a liquid and into which a wall portion of the wall which is movable relative to the channel protrudes. However, rubber seals are also conceivable as sealing means.

The gas pressure changing device preferably comprises a pump, turbine or venturi nozzle. In this way it is possible to ensure in the exhaust gas a continuous gas flow which flows from the sterile region in the direction of an outlet, and thus to effectively prevent the entry of contaminants. Such a gas pressure changing device preferably maintains a pressure difference which is above a predetermined threshold value between the sterile region and the non-sterile region.

Independently of this it is also possible to distribute the exhaust gas (by valve control) to different conduits. Thus for example it may be provided that exhaust gases with a very high gas pressure are recycled and are used for further transformation processes. For example exhaust gas with a high gas pressure could be delivered to a gas reservoir from which gas is extracted for a preliminary blow molding process. Furthermore it is possible to deliver exhaust gas with different gas pressures as a function of the exhaust gas pressure not only to a gas reservoir, but to distribute it to different gas reservoirs in which gas with different pressures is held. As a result different recycling stages for the exhaust gas are generated.

It is preferably provided that in one exhaust gas channel or outlet channel (EXH channel) by means of the gas pressure changing device there is a lower gas pressure than in the remaining sterile region.

The exhaust gas channel is preferably constructed at least in some sections as an annular channel. In this annular channel by means of which the pressure after the last recycling stage is discharged from the transformed containers (preferably into the preliminary blow molding channel), there is preferably a slightly reduced pressure relative to the remaining sterile region, so that during the operation of the gas pressure changing device there is a continuous flow of the gases in direction of the outlet and thus no germs can penetrate into the EXH channel.

Contamination of components and/or groups of components of the transforming system within the clean room is accordingly prevented particularly simply because the pressure in particular in the venting device is always kept below clean room pressure.

By accordingly ensuring a defined pressure gradient it is advantageously ensured that on the venting device a flow direction of a pressure medium for transforming the plastic parisons is always directed only out of the clean room, so that it is conceivable by constructively simple means to prevent germs from outside the clean room entering the clean room through the venting device and contaminating the clean room.

Moreover this measure effects an air flow in only one direction and thus prevents the spread of germs in the direction of the plastic container.

Ideally venting of residual pressure from the plastic container takes place additionally when a corresponding blow molding die is lifted off. The exhaust gas from the transformation process can be discharged almost completely from the container by lifting off of the blow molding die.

With this virtual germ barrier the germs can be prevented extraordinarily simply from crossing over from outside the clean room into the clean room. Additionally the virtual germ barrier proposed here is substantially maintenance-free. The exhaust gas conduit is preferably sterile at any time. Control of a plurality of valves for distribution of the exhaust gas to sterile and non-sterile exhaust gas conduits is not necessary.

Preferably the operation of the pump and/or the application of the predetermined pressure difference is monitored at least intermittently and preferably continuously by means of a pressure sensor or a flow sensor. Furthermore it is provided that the system is stopped (preferably automatically) in the event of failure of the gas pressure changing device.

In order to be able to maintain the pressure difference permanently and to be able to control the gas pressure changing device according to the current requirements, it is advantageous if the venting device comprises means for detecting a process pressure or recovery pressure on the clean room side and/or on the blow mold side.

Pressure sensors already present on the transforming system can optionally be used for this.

Cumulatively or alternatively a non-return valve can be provided on or in the region of the venting device. The danger of an air flow directed into the clean room can likewise be reduced by means of such a non-return valve.

In a particularly preferred variant the gas pressure changing device is disposed between an exhaust gas channel (EXH channel) and an outlet for the exhaust gas. More preferably the (gas) outlet is provided with a sound absorber. The gas pressure changing device is preferably a pump, particularly preferably a rotary pump. With such a rotary pump it is possible very simply to adapt the output according to the currently prevailing pressure difference. In the simplest case the pump may also be a fan disposed in the conduit.

In a further preferred embodiment the gas pressure changing device or the rotary pump is coupled or connected to an inertia mass. In a particularly simple manner this offers the possibility of being able to operate the gas pressure changing device in two different modes:

In a first mode the system functions as a turbine which converts the internal energy of the exhaust gas (or of the fluid flowing through) into a different form of energy. This form of energy may for example be kinetic energy, electrical power, potential energy, heat or another suitable form of energy. Conversion is conceivable for example into potential energy which could for example be stored in a mechanical, magnetic and/or pneumatic spring. The internal energy of the exhaust gas is preferably converted into rotational energy. The turbine converts the internal energy of the exhaust gas into rotational energy and provides mechanical drive energy for the inertia mass. As a result it is possible to store a part of the internal energy of the exhaust gas in the form of kinetic energy. In this mode the flow rate of the fluid or of the exhaust gas which is reduced by the turbine offers the advantage that substantial pressure gradients are degraded less quickly and thus there is a more uniform pressure distribution. This also has a positive effect on the noise level. The lower pressure gradient and the flow rate of the fluid reduced thereby effect less turbulent flows and lower noise levels. Thus it is possible at least temporarily to store the internal energy of the exhaust gas at least partially in an inertia mass. However, electrical storage of the energy is possible, for example by the use of generators and storage means such as batteries, accumulators or capacitors. For this purpose it is provided in a preferred embodiment that the inertia mass is connected to an electric and/or pneumatic motor. Particularly preferably the inertia mass constitutes a rotor of an electric motor. In a preferred embodiment this offers the possibility that the pump/turbine can be driven both (as described above) by the air flow and also electrically and/or pneumatically.

As soon as the pressure difference in the exhaust gas channel becomes too low and thus also the flow rate of the exhaust gas becomes low, there would be an increased danger of contamination of the clean room by contaminants which could proceed against the provided flow direction through the exhaust gas channel in the direction of the clean room. In order to prevent this, the gas pressure changing device coupled to the inertia mass in this case changes autonomously into a second mode, in the gas pressure changing device no longer acts as a turbine but as a pump. In this mode the kinetic energy stored in the inertia mass is used in order to use the gas pressure changing device temporarily as a pump for the exhaust gas in the exhaust gas channel. As a result, even with low pressure in the exhaust gas channel a sufficient flow rate is ensured which effectively prevents the penetration of contaminants into the clean room through the exhaust gas channel.

The pressure in the exhaust gas channel (EXH channel) preferably remains lower than in the clean room. This pressure gradient is maintained until the EXH valve is closed. It is also possible that even with the EXH valve closed the pressure in the exhaust gas channel (EXH channel) is kept at a pressure level which is lower than in the clean room. As a result there is a pressure difference even with the EXH valve closed.

Accordingly in a preferred embodiment the gas pressure changing device can be operated both as a pump and also as a turbine.

Preferably, however, the gas pressure changing device cannot be driven exclusively in the manner described above by the use of the internal energy of the exhaust gas and action as a turbine which converts this energy into rotational energy. The gas pressure changing device preferably has a separate drive (e.g. electric motor). By such a drive the operation of the gas pressure changing device is ensured independently of the drive by a pressure gradient.

Such a separate drive is also advantageous for example during or after cleaning processes. For example in a CIP (Cleaning in Place) or SIP (Sterilisation in Place) process it may be reasonable to generate a pressure gradient in the direction of the outlet of the EXH channel. The pressure gradient is not usually sufficient in order to convey residues from the CIP or SIP process out of the conduits. However, by a separate drive of the gas pressure changing device the pressure gradient can be increased and a removal of cleaning means can be accelerated. Since the cleaning gas is preferably not led off (for example by the sound absorber) into the ambient air, a separate conduit system can be provided. In this case a return line can also be provided for the sterilising medium, but alternatively it is also conceivable to allow the sterilising medium, optionally by means of a filter, into the atmosphere.

This is advantageous in particular after a failure of the system, since then, but optionally also in the event of a replacement of the blow molds, a CIP or SIP process must be carried out by the valve blocks of each blow station. Advantageously the (optionally repaired) gas pressure changing device (e.g. pump) is already switched on again during this process, so that with corresponding valve control the required pressure difference already prevails again.

Therefore the gas pressure changing device is preferably disposed downstream of the valve device.

The venting device preferably has a valve device which constitutes a clean room boundary. More preferably a feed and/or discharge conduit for a cleaning and/or sterilising medium opens into the venting device. In this case it is particularly preferable that the venting device opens on the clean room boundary. In particular it is possible that a feed and/or discharge conduit for a cleaning and/or sterilising medium in/on the valve device which constitutes the clean room boundary opens into the venting device.

The cleaning and/or sterilising medium is in particular prepared centrally and conveyed by means of a rotary distributor into the co-rotating annular channels, from which it arrives at the individual valve units by which it is in turn guided to the EXH conduits.

Alternatively the EXH conduit can also be supplied via a valve in the console (distribution of high pressure blowing air to the individual pressure levels in the annular channels) of the system with cleaning and/or sterilising medium. In this case the cleaning and/or sterilising medium flows through the EXH valve in a direction in which it does not flow during operation.

In a preferred embodiment additional pumps are connected for adjustment of the required pressure difference. This may also take place for example by a corresponding valve control, by which additional pumps are connected to the EXH channel. For example pumps of other machines (such as for example a device for filling containers (filler)) can be connected.

The entire installation preferably has a ventilation system which can also be used for adjustment of the required pressure difference. Accordingly it is possible for the arrangement or the venting device to function decentrally or also centrally. In a preferred embodiment the venting device is associated with a plurality of, preferably all of the blow stations of the system. In particular the installation and in particular the blow molding machine and/or the filling device has a ventilation system which can transport the sterile air located in the isolator or in the clean room into the environment. In this connection a slight negative pressure is preferably generated in the surroundings, so that a flow direction of the sterile air out of the clean chamber is possible in only one direction. It would therefore be possible for the compressed air which is to be vented out of the container and conveyed out of the clean room to be connected to this installation.

Furthermore it would be conceivable that a pump is associated with each of the transforming stations and makes it possible for a flow direction of venting air to be allowed in only one direction. However, it would also be conceivable for the transforming machine to be provided with only one pump which can generate this effect for all transforming stations. Also one pump could be associated in each case with groups of transforming stations. If the quantity of fluid (quantity of gas) to be conveyed for an individual vacuum pump is too great, a further channel would also be conceivable in which exhaust gas is recovered for other processes, but which is at a pressure level reduced again relative to the pressure level(s) at which exhaust gas is delivered for recycling purposes. From this further channel or gas volume excess gas could be led off via a sound absorber into the environment or could be used as working air for other processes (such as for example the control of the stretching cylinders etc.).

In a further preferred embodiment an overpressure of sterile gas continuously prevails in the (sterile) EXH channel, so that at the outlet thereof no germs from the exterior can penetrate into the EXH channel. This could be achieved for example by a bypass provided with a throttle in a valve block or a plurality of valve blocks. Preferably by such a gas pressure changing device gas from the preliminary blow molding channel or sterile fluid (gas) from another (sterile) conduit system can be introduced into the EXH channel in such a way that the required pressure difference is maintained. Alternatively or in addition a device for changing the gas pressure by a (valve-controlled) connection in the console is conceivable. Moreover it would be conceivable to design the EXH valve in the valve block as a double seat valve so that the air is introduced via this valve either from the bottle or from another (sterile) channel into the EXH channel. In this case the sterile air supply could for example be ensured by a flywheel even in the event of (temporary) disruptions.

If in this embodiment the EXH channel is connected to the compressed air supply by means of a connection option (a valve or a pressure reducer or a conduit constriction), then this connection option can also serve as a gas pressure changing device if (sterile) blowing air which was not yet in the container is conveyed continuously by means of this connection option into the EXH channel. This connection option could also be accommodated in a valve block of a blow station. The connection option constitutes, as it were, a short-circuit.

Moreover the present invention is directed to an installation for treating containers which has a system as described above.

Furthermore the present invention relates to a method for transforming plastic parisons into plastic containers in a clean room by means of at least one blow station comprising a blow mold in which for the transformation of the plastic parisons these plastic parisons are supplied with at least one process pressure, and the process pressure, or a process pressure reduced to recovery pressure, is vented by means of a venting device into the atmosphere, wherein the gas pressure in the venting device is changed at least temporarily by at least one gas pressure changing device, wherein the gas pressure changing device produces and/or adjusts and/or maintains a pressure difference between the clean room and/or a drain conduit connected to the clean room of the venting device.

In this case the pressure difference between the clean room and venting device is preferably adjusted and/or maintained by means of a pump.

The gas pressure in the clean room is preferably higher than in the venting device and the gas pressure in the venting device is higher than in the free atmosphere. For example the overpressure (by comparison with the atmosphere) in the clean room is 20 mbar and the overpressure in the venting device is 10 mbar.

It is also conceivable that the gas pressure in the clean room is preferably higher than in the free atmosphere and in the clean room if sterile air is delivered to the venting device. For example the overpressure (by comparison with the atmosphere) in the clean room is 10 mbar and the overpressure in the venting device is 20 mbar. Thus if the EXH valve is opened after the blowing process, after the (substantial) venting not all of the exhaust gas flows out of the container—this is then only implemented (partially) by lifting off of the blow molding die.

More preferably at least a proportion of the internal energy of the exhaust gas is recovered at least intermittently by a turbine. The energy recovered by the turbine is preferably stored at least temporarily in an inertia mass in the form of kinetic energy. In addition or alternatively, storage in the form of electrical energy is for example also possible. The energy could for example be stored in an accumulator. Moreover it would also be conceivable to feed the energy into a network, where the energy is available for other processes.

Moreover, it is preferable that a continuous flow of gas out of the clean room and/or a conduit connected to the clean room with an opened connection is caused by the venting device.

German patent application number 10 2013 110 132.1 filed Sep. 13, 2013 is incorporated herein by reference for all purposes.

Further advantages, aims and characteristics of the present invention are explained with reference to the appended drawings and the following description in which for example a transforming system and venting devices with at least one gas pressure changing device for adjusting a pressure difference between the clean room and the venting device are illustrated and described.

### DESCRIPTION OF THE DRAWING

FIG. 1 shows a schematic view of an installation for producing plastic containers with a blow station disposed in a clean room;

FIG. 2 shows schematically an example of a configuration of the conduit system in a transforming system and venting device;

FIG. 3 shows schematically the structure of the conduit system in a transforming system; and

FIG. 4 shows schematically a circuit diagram of a venting valve as a function of an exhaust gas pressure.

### DETAILED DESCRIPTION

FIG. 1 shows a schematic representation of an installation for producing plastic containers. This installation 50 has a heater 30 in which plastic parisons 10 are heated. In this case these plastic parisons 10 are led through this heater 30 by means of a transport device 34, such as in this case a circulating chain, and in this case is heated by a plurality of heating elements 31. A transfer unit 36 which transfers the plastic parisons 10 to a sterilising unit 32 adjoins this heater 30. In this case the sterilising unit 32 also has a transport wheel 37 and sterilising units can be disposed on this transport wheel 37 or also stationary. In this region sterilisation is possible for example by hydrogen peroxide gas or also by electromagnetic or UV radiation. In particular an internal sterilisation of the parisons is carried out in this region. A sterilisation in the region of the heater 30 or before the heater 30 is also conceivable.

The reference sign 20 designates overall a clean room of which the outer boundaries are indicated here by the line L. In a further preferred embodiment the clean room 20 is not only disposed in the region of the transport wheel 2 and the filling unit 40, but may already begin in the region of the heater 30, the sterilising unit 32, the delivery of plastic parisons and/or the production of plastic parisons. It will be recognised that in the illustrated example the clean room 20 begins in the region of the sterilising unit 32. In this region air lock means can be provided in order to introduce the plastic parisons into the clean room 20 without a larger quantity of gas flowing out of the clean room 20 and so being lost.

As indicated by the clean room boundary 18 or broken line L, the clean room 20 is adapted to the external shape of the individual system components. In this way the volume of the clean room can be reduced.

The reference sign 1 designates overall a transforming device in which a plurality of blow stations 8 is disposed on a transport wheel 2. With these blow stations 8 the plastic parisons 10 are expanded to form containers 10a. Even though it is not shown in detail in FIG. 1, it is possible that the entire region of the transport device 2 is not located within the clean room 20, but the clean room 20 or isolator is configured like a channel, so larger regions of the installation such as for example drives, support structures, pressure generating devices and other devices are disposed outside the clean room.

The reference sign 22 relates to a delivery device which transfers the parisons to the transforming device 1 and the reference sign 24 relates to a discharge unit which discharges the produced plastic containers 10a from the transforming device 1. It will be recognised that in the region of the delivery device 22 and the discharge unit 24 the clean room 20 has recesses in each case which contain these devices 22, 24. In this way a transfer of the plastic parisons 10 to the transforming device 1 or a take-up of the plastic containers 10a from the transforming device 1 can be achieved in a particularly advantageous manner.

The expanded plastic containers are transferred to a filling device 40 by a transfer unit 42 and from this filling device 40 they are then discharged via a further transport unit 44. In this case the filling device 40 is also located within said clean room 20. Also in the case of the filling device it would be possible that the entire filling device 40 with for example a reservoir for a drink is not disposed completely within the clean room 20, but here too only those regions through which the containers actually pass. In this respect the filling device could also be constructed in a similar way to the device 1 for transforming plastic parisons 10.

As mentioned, in the region of the system 1 the clean room 20 is reduced to the smallest possible region, namely essentially to the blow stations 8 themselves. Due to this compact configuration of the clean room 20 it is possible to actually produce a clean room 20 more easily and quickly, and also keeping it sterile in the operating phase is less complex. Also less sterile air is required, which leads to smaller filter systems and also the risk of uncontrolled turbulence is reduced.

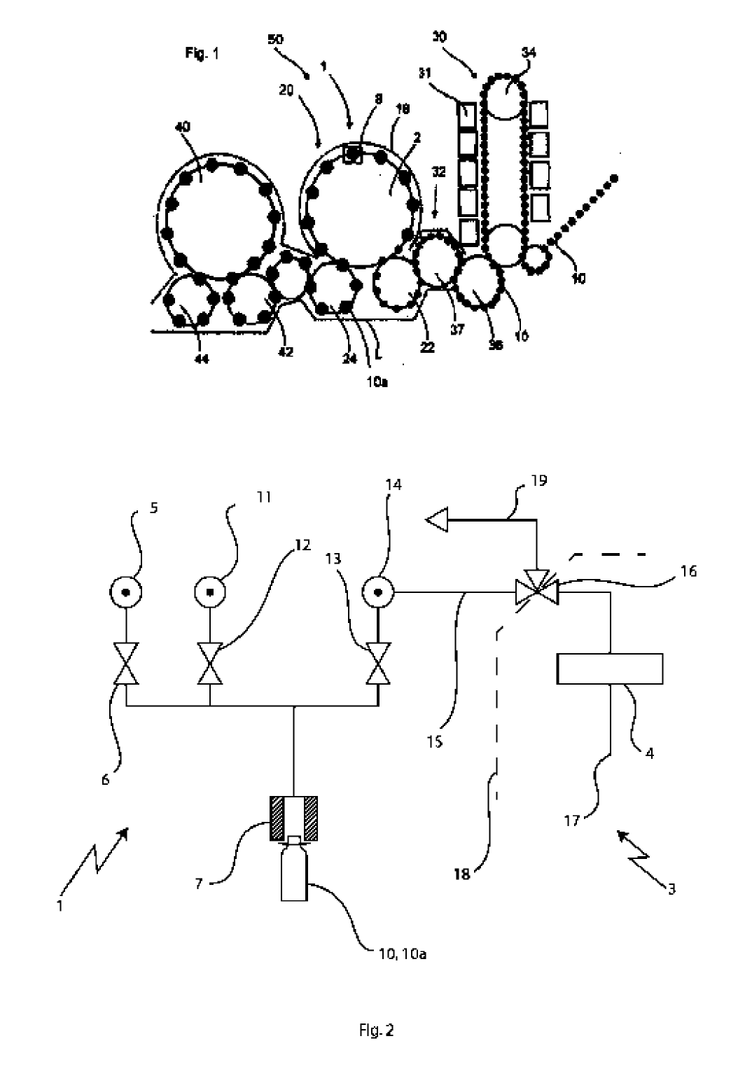

FIG. 2 shows schematically an example of a configuration of the conduit system in a transforming system 1 and venting device 3 with at least one gas pressure changing device 4 for adjusting a pressure difference between the clean room 20 and the venting device 3.

In this example the conduit system comprises an annular channel 5 which is used for example for a preliminary blow molding pressure p1. By means of a valve 6 and a corresponding feed line the preliminary blow molding pressure p1 can be conveyed to a blow molding die 7 which in turn is part of a blow station 8 (not shown in FIG. 2). In this blow station 8 a parison 10 can be expanded to form a container 10a by means of the pressure applied on the blow molding die 7. For this purpose, however, the preliminary blow molding pressure p1 of for example between 5 and 20 bar is not generally sufficient, so that by means of a further annular channel 11a different pressure, namely the final blow molding pressure p2, can be directed by means of an associated valve 12 into the conduit system and thus to the blow molding die 7. At the introduction of the final blow molding pressure p1 the valve 6 for the preliminary blow molding pressure p1 is closed.

After expansion of the parison 10 to form a container 10a the valve 12 is also closed and the gas present in the conduit system and the container, which has an increased pressure, is supplied by means of a further valve 13 to an exhaust gas annular channel (EXH annular channel) 14. This annular channel 14 is also sterile and is thus part of the clean room 20. The gas located in the annular channel 14 can be delivered for further use for example to a compressed gas reservoir for the preliminary blow molding pressure p1. The drawing off of the (sterile) exhaust gas located in the annular channel 14 takes place by means of a conduit (not shown) into the compressed gas reservoir for the preliminary blow molding pressure p1 up to a predetermined pressure. As soon as the pressure in the annular channel 14 falls below this level, remaining exhaust gas is discharged via a corresponding discharge conduit 15. However, for recycling of compressed air it is also possible after the closing of the valve 12 to open the valve 6 again and only then to open the valve 13. A switching valve 16 which preferably forms the clean room boundary 18 is located in this discharge conduit 15. Downstream of this valve a pump 4 is disposed which with the valve 16 open and also with a low residual pressure in the annular channel 14 ensures a continuous gas stream in the direction of the gas outlet 17. As a result contaminants are simply and at the same time effectively prevented from penetrating through the outlet 17 and back in the direction of the annular channel 14.

The valves 6, 12 and 13 are disposed in a valve block which is also part of every blow station 8. The aforementioned console is located upstream of the annular channels 5, 11 and 14 and distributes the blowing air by means of pressure reducers to the annular channels 5 and 11. In an embodiment it is also possible for the annular channel 14 to be supplied directly from the console in order to generate the overpressure. In this case the pump 4 can also be omitted.

In the event of a shutdown of the transforming device the valve 16 can be closed and simultaneously the entire conduit system upstream of this valve can be set at a slight overpressure, so that also no contamination of the clean room can occur during a (short) shutdown. The cleaning of the valve 16 and of the conduit system disposed downstream of this valve is possible through a so-called CIP channel 15, 19. Through this channel 15, 19 a cleaning or sterilising solution can be conveyed through the valve 16 and into the conduit system located downstream thereof. This preferably takes place at a time at which the pump 4 is already again in operation, so that a continuous gas stream to the outlet 17 can be ensured. The apparatus (or pump) (4) can run intermittently or continuously. In a variant (not shown) the apparatus (4) constitutes a connection to the (preferably continuously running) exhaust air system of the entire installation. Thus when the switching valve 16 again releases the connection to the pump, the predetermined pressure difference is again already applied, which ensures the continuous gas stream. Such a continuous gas stream significantly reduces the noise pollution on the gas outlet 17, both during cleaning and also during regular operation, by comparison with systems with greatly fluctuating pressures. In addition a sound absorber (not shown) can also be provided on the gas outlet 17. The CIP or SIP medium here preferably flows in the sterilisation mode through the channel 14 via the conduit 15 via the valve 16 into the conduit 19 and from there back into the clean room. In this case 4 and 17 are not sterilised and the line 18 forms the clean room boundary.

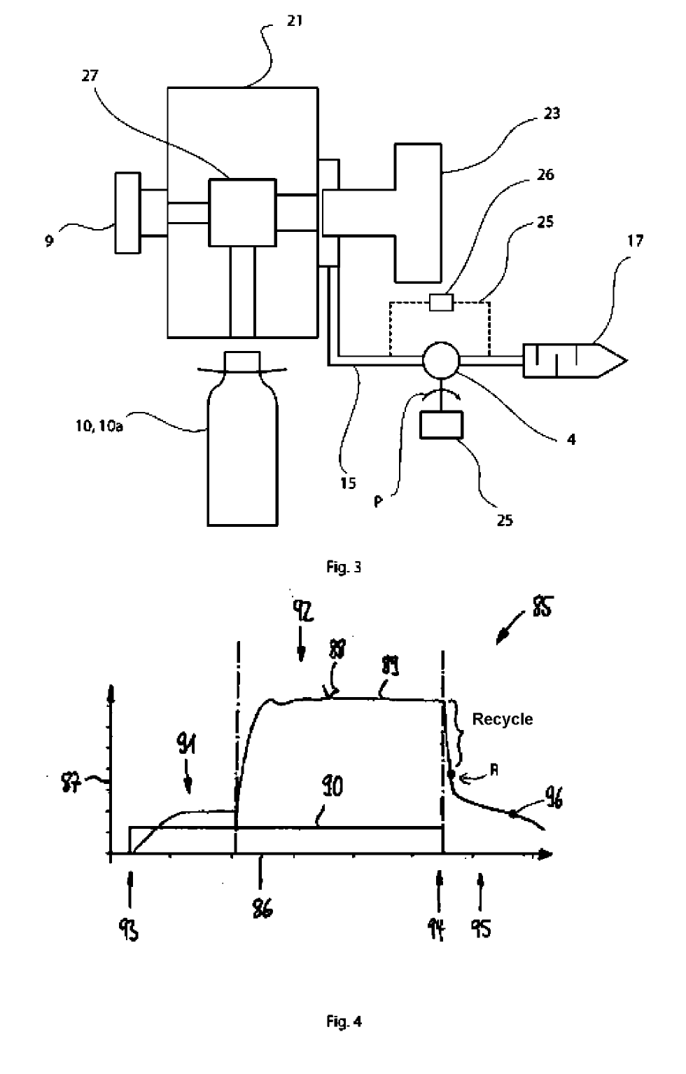

FIG. 3 shows schematically the structure of the conduit system in a transforming system 1. By corresponding connections 9, which are connected by means of conduits (not shown) to the pressure reservoir for the different pressures p1, p2 . . . pi, gas at the provided pressure can be introduced into an annular space 27 of the valve block or blow molding piston 21. By means of the pressure prevailing there a parison 10 can be expanded to form a container 10a. The resulting sterile exhaust gas at elevated pressure is discharged from the container 10a and the conduit system by a EXH piston 23 and the exhaust gas channel (EXH channel) 15. A pump 4 located in the exhaust gas channel 15 ensures a continuous flow of the exhaust gas in the direction of the outlet 17, which in this case has a sound absorber.

In the event of a large pressure difference between the proportion of the exhaust gas channel 15 on the clean room side and the outlet 17, the pump 4 functions as a turbine which is driven by the air flow flowing through it and is set in rotation (in the direction of the arrow P). The internal energy (flow energy) of the exhaust gas is stored in the form of kinetic energy (rotational energy), an inertia mass being driven. After the pressure in the container 10a and in the clean room 20 or the sterile proportion of the exhaust gas channel 15 falls below a predetermined pressure and thus the pressure difference is insufficient to ensure a continuous flow in the direction of the outlet 17, the device 4 for changing gas pressure which previously acted as a turbine then acts as a pump and ensures maintenance of the continuous exhaust gas stream. The energy source is the kinetic energy stored in the inertia mass. As already described above, however, another drive source for the pump is preferably additionally provided in order (for example after a CIP or SIP process) to establish the continuous flow independently of previous pressure differences.

As illustrated by the conduit 25 shown by broken lines, a bypass channel can optionally be provided which preferably has a non-return valve 26. In this way for example if the EXH valve is closed a sufficient discharge of the gases can be ensured. Moreover such a bypass channel 25 may be sensible in order to protect the device 4 for changing gas pressure in its function as a turbine against extraordinary loads in the event of particularly high pressure differences.

The diagram 85 shown in FIG. 4 has a time axis 86 and a pressure axis 87. In the diagram 85 a pressure curve 88 is shown with regard to a process pressure 89 as well as a control valve signal 90.

The pressure curve 88 represents a preliminary molding pressure p1 91 and a final molding pressure p2 92.

If the control valve signal 90 is switched on at a time 93 a control pressure chamber is supplied with the control pressure and the venting valve 13 closes. Consequently the process pressure 89 can increase and a plastic parison 10 can be correspondingly expanded.

If the control valve signal 90 is switched off at a later time 94 the venting valve 13 opens and the process pressure 89 is vented.

Through the device 4 for changing gas pressure acting as a turbine the curve flattens after the exhaust gas pressure recovery is switched off at the point R. Accordingly the point R identifies the pressure up to which gas is directed into the annular channels p1 and pi and thus recycled. This is shown with the interval “Recycled” in FIG. 4. If at a venting time 95 the process pressure 89 reaches a predetermined anti-contamination pressure 96, the device 4 for changing gas pressure functions as a pump and ensures a continuous flow before a sufficient pressure difference is again ensured by starting of the next venting process. The anti-contamination pressure 96 is in particular in a pressure range of a few bars, in particular between 0.5 and 5 bar, and particularly preferably at atmospheric pressure.

Forced venting of the low anti-contamination pressure 96 in particular out of the container 10a can take place for example when a blow molding die on the blow station 8 can be lifted off.

The applicant reserves the right to claim all the features disclosed in the application documents as essential to the invention in so far as they are individually or in combination novel over the prior art.

### LIST OF REFERENCE SIGNS

1: transforming device
2: transport wheel, transport device
4: gas pressure changing device, pump, turbine
5: annular channel p1
6: valve p1
8: blow station
9: connection
10: plastic parisons
10a: container
11: annular channel p2
12: valve p2
13: valve
14: EXH annular channel
15: exhaust gas conduit, EXH channel
16: valve
17: outlet, sound absorber
18: clean room wall
19: CIP, SP channel
20: clean room
21: valve block, blow molding piston
22: delivery device
23: EXH piston
24: discharge unit
25: bypass channel
26: non-return valve
27: annular space
30: heater
31: heating elements
32: sterilising device
34: transport device
36: transfer unit
37: transport wheel
40: filling unit
42: transfer unit
44: transport unit
50: installation
85: diagram
86: time axis
87: pressure axis
88: pressure curve
89: process pressure
90: control valve signal
91: preliminary molding pressure
92: final molding pressure
93: time
94: later time
95: venting time
96: anti-contamination pressure
97: atmospheric pressure level
P: arrow
R: recovery pressure
U: surrounding environment

1. A system (1) for transforming plastic parisons (10) into plastic containers (10a) with a clean room (20), with at least one blow station (8) comprising a blow mold for shaping the plastic parisons (10) by means of at least one process pressure (p1, p1, p2) and with a venting device (3) for venting the process pressure, or a process pressure reduced to recovery pressure (R), into the atmosphere (U), in which the venting device (3) comprises at least one gas pressure changing device (4), wherein the gas pressure changing device (4) can produce, maintain and in particular also adjust a pressure difference between the clean room (2) and/or a drain conduit (14, 15) connected to the clean room and the venting device (3).

2. The system (1) according to claim 1, wherein the venting device (3) has a valve device (16, 23) which constitutes a clean room boundary (18).

3. The system (1) according to claim 1, wherein the venting device (3) has a feed and/or discharge conduit (19) for a cleaning and/or sterilising medium, wherein this feed conduit (19) preferably opens into the venting device at the clean room boundary (18).

4. The system (1) according to claim 1, wherein the gas pressure changing device (4) comprises a pump, turbine or venturi nozzle.

5. The system (1) according to claim 4, wherein the gas pressure changing device (4) can be operated both as a pump and also as a turbine.

6. The system (1) according to claim 2, wherein the gas pressure changing device (4) is disposed downstream of the valve device (16, 23).

7. The system (1) according claim 1, wherein the gas pressure changing device (4) is connected to an inertia mass.

8. The system (1) according claim 1, wherein the exhaust gas has an internal energy, and the internal energy of the exhaust gas can be at least temporarily stored at least partially in an inertia mass.

9. The system (1) according to claim 1, wherein the feed conduit (19) for a cleaning and/or sterilising medium opens into the valve device (16) at the clean room boundary (18).

10. The system (1) according claim 1, wherein the venting device (3) is associated with a plurality of the blow stations (8) of the system (1).

11. An installation for treating containers (2), wherein it has a system (1) according to claim 1.

12. A method for transforming plastic parisons (10) into plastic containers (10a) in a clean room (20) by means of at least one blow station (8) comprising a blow mold in which for the transformation of the plastic parisons (10) these plastic parisons are supplied with at least one process pressure (p1, p2, pi) and the process pressure, or a process pressure reduced to a recovery pressure (R), is vented by means of a venting device (3) into the atmosphere (U), wherein the gas pressure in the venting device (3) is changed at least temporarily by at least one gas pressure changing device (4), wherein the gas pressure changing device (4) produces and/or adjusts and/or maintains a pressure difference between the clean room (2) and/or a drain conduit (14, 15) connected to the clean room and the venting device (3).

13. The method according to claim 12, wherein the pressure difference between the clean room (2) and the venting device (3) is adjusted and/or maintained by means of a pump.

14. The method according to claim 12, wherein at least a proportion of the internal energy of the exhaust gas is recovered at least intermittently by a turbine.

15. The method according to claim 14, wherein the energy recovered by the turbine is stored at least temporarily in an inertia mass in the form of kinetic energy.

16. The method according to claim 12, wherein a continuous flow of gas out of the clean room and/or a conduit (14, 15) connected to the clean room with an opened connection (13) is caused by the venting device (3).
